(19) United States
(12) Patent Application Publication
(10) Pub. No.: US 2010/0116146 A1
(43) Pub. Date: May 13, 2010

(54) HEIGHT REGULATING MECHANISM OF GRILL PAN

(75) Inventor: Lifeng XIE, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/615,611

(22) Filed: Nov. 10, 2009

(30) Foreign Application Priority Data
Nov. 12, 2008 (CN) 200820146363.6

(51) Int. Cl. G07F 9/10

(52) U.S. Cl. 99/357

(57) ABSTRACT

A height regulating mechanism of grill pan, comprising a first lever, an eccentric gear and a gear pivot; one end of said first lever pivotally connected to the rear portion of one side of the lower shell of the grill pan, the other end fixed to the upper shell of the grill pan; the eccentric gear rotatably connected to the first lever, and the gear pivot is disposed on the lower shell of the grill pan and beneath the eccentric gear. Compared to the prior art, the height of the grill pan can be adjusted by eccentric gear to control the distance between the upper pan and lower pan.

### FIELD OF THE INVENTION

The present invention relates to a structure of grill, more particularly, to a height regulating mechanism of grill pan.

### BACKGROUND OF THE INVENTION

Generally, the grill with upper pan and lower pan of prior art only has two state: one is open state, in which the upper pan is lift totally from the lower pan; another is close state, in which the upper pan is close to the lower pan, in this status, if food with thin thickness is cooked, the cooking effect is well, however, if food with thick thickness is cooked, the cooking effect is not satisfying for that the height between the upper pan and lower pan can not be adjusted.

A utility model with the title as “A structure-improved roasting machine” is disclosed in CN PAT NO 200520004999.3, which comprises a first pan and a second pan with a handle, wherein the second pan is combined with the upper part of the first pan. Both sides near the back end of the first pan are provided with pivot joint parts, an elliptical groove cave and a limited surface are formed in each of the pivot joint parts, and the edge of the elliptical groove cave is extended to form a horizontal stopping rib. The front end of the second pan is provided with notches corresponding to the pivot joint parts of the first pan. Both side edges of the second pan are provided with through holes, a supporting part of the handle is arranged between the through holes, and a positioning column, a positioning rib and an arc rib are inwardly formed along the front ends of both sides of the handle. According to the thickness and the quantity of food and material, the second pan of the utility model can form a covering state, a vertical state or a horizontal state, but the grill with the three states can not achieve well cooking effect if the grill can not adjust the distance between the upper pan and the lower pan according to the thickness of the food.

### SUMMARY OF THE INVENTION

The primary of the invention is to obviate the drawbacks that the distance between the upper pan and the lower pan can not be adjusted according to the thickness of the food in prior art by providing a height regulating mechanism of grill pan.

The object of the present invention is achieved by providing: a height regulating mechanism of grill pan comprising a first lever, an eccentric gear and a gear pivot, one end of said first lever pivotally connected to the rear portion of one side of the lower shell of the pan, and the other end fixed to the upper shell of the pan, said eccentric gear rotatably connected to said first lever, and said gear pivot is disposed on the lower shell of said pan and beneath said eccentric gear.

The periphery of said eccentric gear is formed with wave-shaped step teeth.

Said gear pivot is extruded out from the surface of the lower shell of said pan.

According to a preferred embodiment of the present invention, said mechanism further comprises a second lever, said second lever is symmetrically to said first lever, said first lever is connected with said second lever via a connecting rod, said connecting rod pivotally connected with at least two protrusions extruded from the rear portion of the lower shell of grill pan, said first lever and said second lever are rotated synchronously with said connecting rod.

According to a preferred embodiment of the present invention, said eccentric gear is connected to a knob, said knob is rotated synchronously with said eccentric gear.

Further, said eccentric gear is disposed in the inner side of said first lever and fixedly connected to said knob by a connecting clamp of said eccentric gear pass through said first lever.

By abovementioned description of the present invention, compared with the prior art, the height regulating mechanism of grill pan of the present invention has the following advantages:

Firstly, the height of the pan can be adjusted among several heights by adjusting the eccentric gear to control the distance between the upper pan and lower pan, thus food with different thickness can be cooked to achieve well cooking effect;

Secondly, the upper pan can be maintained in a stable state when the upper pan and lower pan disposed in a certain height by the corporation of the first lever, second lever and connecting rod, which enhances the strength and make the pan to be symmetrical in entirety, and the appearance is improved;

Thirdly, the knob provided on the eccentric gear facilitates the operation for the user, which is of more humanization.

In summary, the height regulating mechanism of grill pan of the present invention is well designed to facilitate the user to cook food with different thickness, thus has high promotion value.

### BRIEF DESCRIPTION OF THE DRAWINGS

FIG. 1 is an exploded view of the height regulating mechanism of grill pan of the present invention which is applied in grill in an embodiment.

FIG. 2 is an assembled view of the height regulating mechanism of grill pan of the present invention applied in grill in an embodiment.

FIG. 3 is a structure view of the height regulating mechanism of grill pan of the present invention applied in grill when the upper pan and the lower pan are close to each other in an embodiment.

FIG. 4 is a structure view of the height regulating mechanism of grill pan of the present invention applied in grill when the upper pan is rise in an embodiment.

### DETAILED DESCRIPTION OF THE PREFERRED EMBODIMENT

The details of the embodiment of the invention are set forth in the accompanying drawings. The grill pan which the height regulating mechanism of the present invention is applied comprises an upper shell and a lower shell which cover to each other, an upper pan and a lower pan are embedded in the upper shell and lower shell respectively.

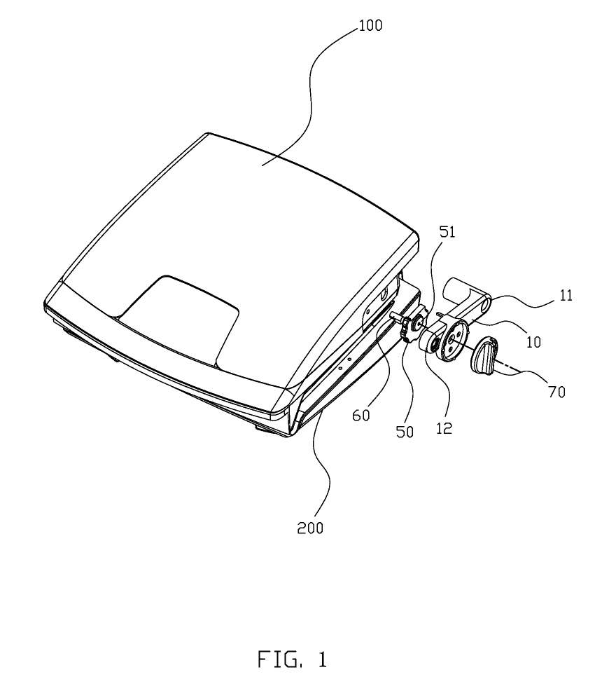

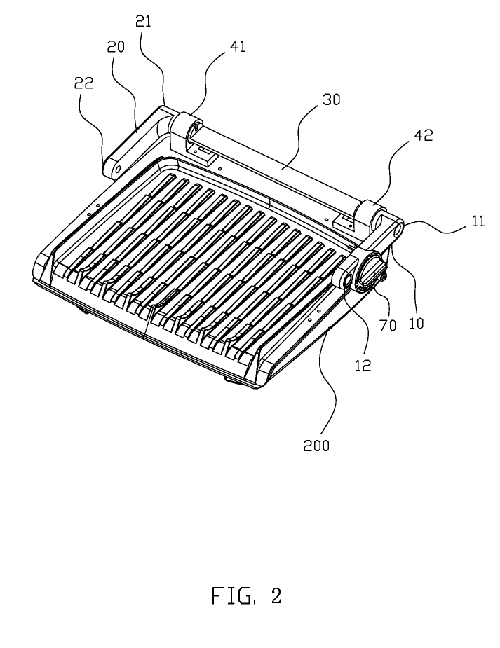

Referring to FIG. 1 and FIG. 2, the height regulating mechanism of the present invention comprises a first lever 10, a second lever 20, one end 11 of the first lever 10 is connected to one end 21 of the second lever 20 via a connecting rod 30 pivotally connected to the two protrusions 41, 42 protruded out from the rear portion of the lower shell of the pan, the first lever 10 and the second lever 20 are rotated synchronously with the connecting 30, the other ends 12,22 of the first lever 10 and second lever 20 are fixedly connected to two side walls of the upper shell of the pan respectively, and the second lever 20 is symmetrically to the first lever 10.

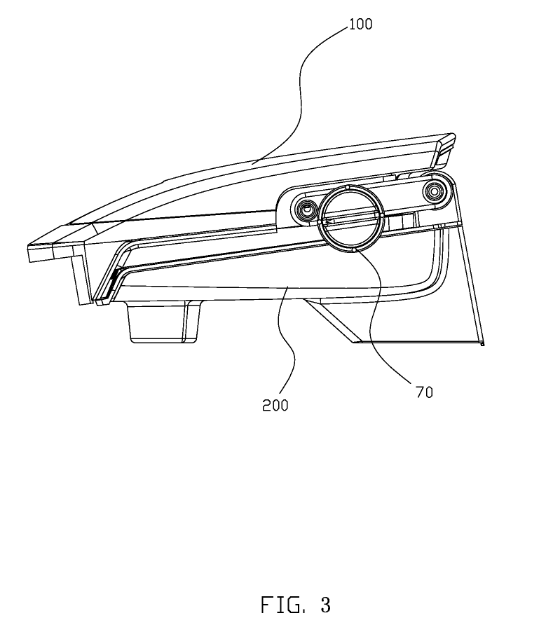

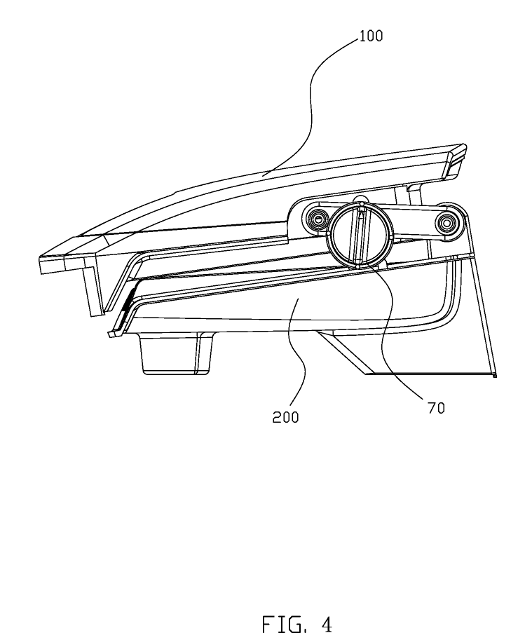

Referring to FIG. 1 and FIG. 2, an eccentric gear 50 is disposed in the inner side of the first lever 10, the eccentric gear 50 is connected to a knob 70 disposed in the outside of the first lever 10 by a connecting clamp 51 of the eccentric gear 50 pass through the first lever 10, the eccentric gear 50 and the knob 70 can rotate relative to the first lever 10. Under the eccentric gear 50, a gear pivot 60 is protruded out from the lower shell 200, the periphery of the eccentric gear 50 is formed to be with wave-shaped step teeth, the eccentric 50 is cooperated with the gear pivot 60 that each time a tooth of the eccentric gear 50 is rotated, a different height is formed between the upper pan and the lower pan. Referring to FIG. 3 and FIG. 4, FIG. 3 shows that the upper pan close to the lower pan; FIG. 4 shows that the upper pan rise to a certain height.

A preferred embodiment of the invention has been described. Nevertheless, it will be understood that various modifications may be made without departing from the spirit and scope of the invention. Accordingly, other embodiments are within the scope of the following claims.

What is claimed is:

1. A height regulating mechanism of grill pan comprising: a first lever, an eccentric gear and a gear pivot, one end of said first lever pivotally connected to the rear portion of one side of the lower shell of the pan and the other end fixed to the upper shell of the pan; wherein said eccentric gear rotatably connected to said first lever, and said gear pivot is disposed on the lower shell of said pan and beneath said eccentric gear.

2. The height regulating mechanism of grill pan according to claim 1, the height regulating mechanism of grill pan further comprising a second lever; wherein said second lever is symmetrically to said first lever and connected with said first lever via a connecting rod; said connecting rod pivotally connected with at least two protrusions extruded from the rear portion of the lower shell of grill pan; said first lever and said second lever are rotated synchronously with said connecting rod.

3. The height regulating mechanism of grill pan according to claim 1, wherein said eccentric gear is connected to a knob; said knob is rotated synchronously with said eccentric gear.

4. The height regulating mechanism of grill pan according to claim 3, wherein said eccentric gear is disposed in the inner side of said first lever and fixedly connected to said knob by a connecting clamp of said eccentric gear pass through said first lever.

5. The height regulating mechanism of grill pan according to claim 1, wherein the periphery of said eccentric gear is formed with wave-shaped step teeth.

6. The height regulating mechanism of grill pan according to claim 1, wherein said gear pivot is extruded out from the surface of the lower shell of said pan.

7. The height regulating mechanism of grill pan according to claim 6, wherein said gear pivot is extruded out from the surface of the lower shell of said pan.
